(19) United States
(12) Patent Application Publication
(10) Pub. No.: US 2008/0067766 A1
(43) Pub. Date: Mar. 20, 2008

(54) Snow removal device

(76) Inventor: Mark Watson, Galloway, OH (US)

Correspondence Address: Mr. Edward J. Timmer, P.O. Box 770, Richland, MI, 49083-0770, US

(21) Appl. No.: 11/523,799

(22) Filed: Sep. 19, 2006

(51) Int. Cl. B62B 1/00

(52) U.S. Cl. 280/47.27

(57) ABSTRACT

A snow removal device can be releasably clamped to a platform of a wheeled dolly and then unclamped therefrom to permit use of the dolly for other tasks. The snow removal device comprises a snow pushing member having an attachment frame that includes first and second clamping members that are adapted to releasably clamp on the platform of the dolly.

### FIELD OF THE INVENTION

The present invention relates to snow removal devices and, more particularly, to a snow removal device that is releasably clamped to a wheeled dolly for use in removing snow from a path and removable from the dolly for storage.

### BACKGROUND OF THE INVENTION

Various types of snow removal devices have been developed over the years to remove snow from a path, such as a driveway or walkway. For example, electric and motor-powered snow blowers are widely available. They are expensive and can require considerable storage space when not in use.

Manual snow removal devices also have been developed having a handle permanently connected to a snow pushing blade to enable a user to manually push the blade to displace snow from a path. Some of these devices include wheels to facilitate pushing of the snow removal device. Such snow removal devices are usable only for snow removal and can require considerable storage space when not in use.

### SUMMARY OF THE INVENTION

The present invention provides a snow removal device that can be releasably clamped to a wheeled dolly and then unclamped therefrom to permit use of the dolly for other tasks.

In an illustrative embodiment of the invention, the snow removal device comprises a snow pushing member and an attachment frame that is connected to the snow pushing member and that includes first and second clamping members that are movable and adapted to releasably clamp on a platform of the wheeled dolly. The snow pushing member preferably includes a replaceable blade at the lowermost edge.

In another particular illustrative embodiment of the invention, the clamping members form a channel in which the platform is clamped. For example, the first and second clamping members include respective first and second elongated C-shaped channels facing each other and between which the platform is clamped. The clamping members are adjustably movably disposed on the frame so to move toward one another to clamp on the platform and away from one another to unclamp from the platform. The attachment frame includes adjustment slots such that fasteners can extend through the clamping members and the slots in a manner to releasably clamp the clamping members on the platform.

In a further particular illustrative embodiment of the invention, the attachment frame is connected to the back side of the snow pushing member in a manner to provide an access space therebetween for releasably clamping the clamping members on the platform of the dolly.

The snow removal device is attached to the platform of the dolly for use in removing snow. The combination of the snow removal device mounted on the dolly is pushed by the user to remove snow from a path. The snow removal device can be simply unfastened from the platform of the dolly and stored in a relatively small storage space until the next use in removing snow. In the meantime, the dolly can be used for other tasks.

Advantages and features of the invention will become more readily apparent from the following detailed description taken with the following drawings.

### DESCRIPTION OF THE DRAWINGS

FIG. 1 is a perspective view of the snow removal device pursuant to an illustrative embodiment of the invention prior to fastening to a conventional wheeled dolly.

FIG. 2 is a perspective view of the snow removal device pursuant to the illustrative embodiment of FIG. 1 after fastening to a conventional wheeled dolly.

FIG. 3 is an elevational view of the combination of the snow removal device and the dolly of FIG. 2.

FIG. 4 is an enlarged elevational view of the snow removal device.

FIG. 5 is a perspective view of the attachment frame of the snow removal device showing the clamping members that are adjustable relative to slots in the frame.

FIG. 6 is a perspective view of the attachment frame taken in the opposite direction from FIG. 5.

### DESCRIPTION OF THE INVENTION

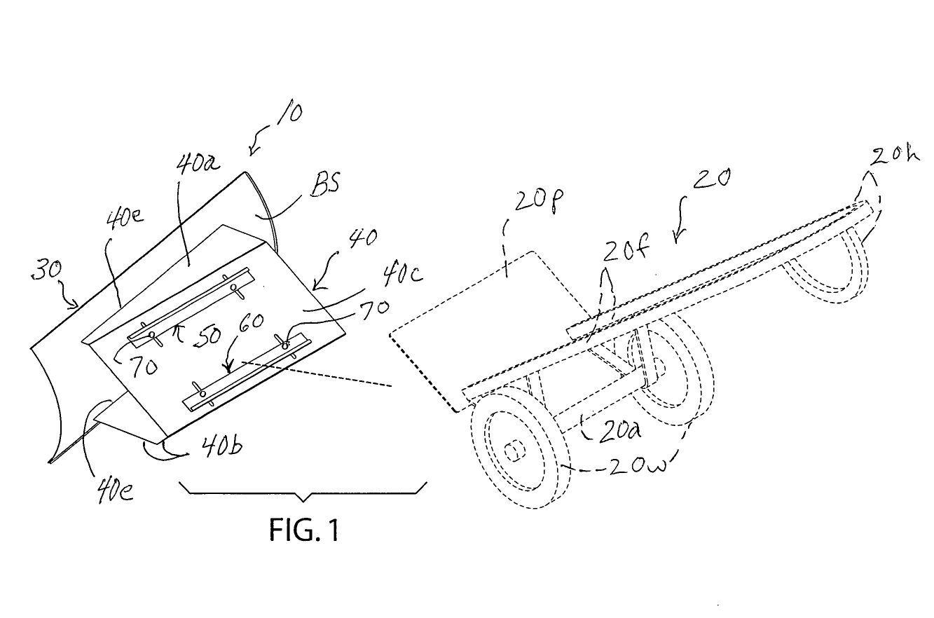

Referring to FIG. 1, a snow removal device 10 pursuant to an illustrative embodiment of the invention is shown prior to fastening to a platform 20p of a conventional wheeled truck or dolly 20. As is well known, the dolly 20 includes a frame 20f connected to the platform 20p on which a load is placed and supported for movement. The dolly includes wheels 20w mounted on an axle 20a mounted on the frame 20f. The dolly is pushed around by an individual using handle 20h that is attached to frame 20f. Such a dolly is available commercially at most hardware stores.

Referring to FIGS. 1-5, snow removal device 10 includes a snow pushing member 30 having a front side FS for pushing snow and an attachment frame 40 that is connected to a back side BS of the snow pushing member. For example, the attachment frame 40 includes frame sections 40a, 40b having edges 40e welded or otherwise fastened to the back side of the snow pushing member 30. The frame sections 40a, 40b are connected together by a third frame section 40c. The frame sections 40a, 40b, 40c typically are made of a suitably bent single steel or aluminum sheet or other material, although the invention is not so limited. The snow pushing member 30 likewise can comprise a steel or aluminum sheet or other material.

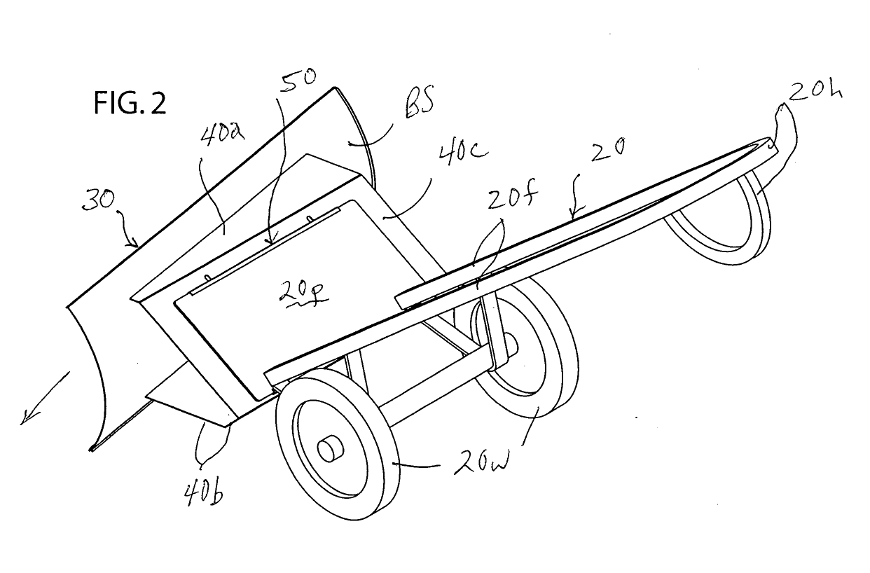

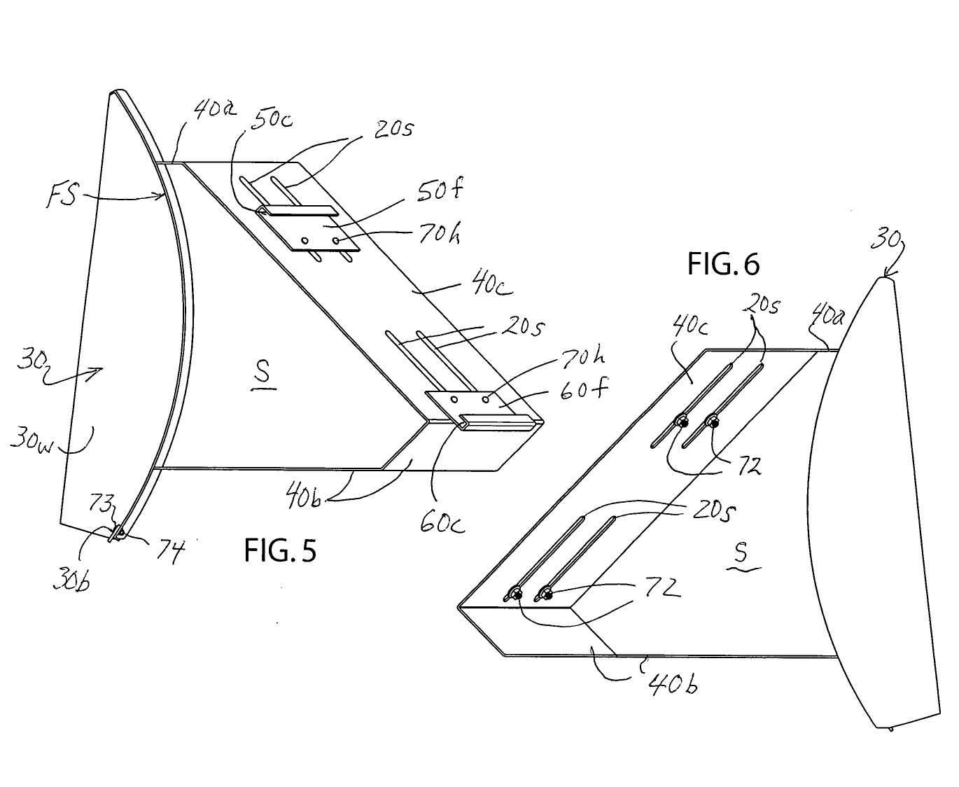

First and second clamping members 50, 60 are disposed on the frame section 40c and are adapted to releasably clamp on platform 20p of the wheeled dolly 20. The clamping members 50, 60 form a channel therebetween in which the platform 20p is clamped as illustrated in FIGS. 2-4. To this end, the first and second clamping members 50, 60 include respective first and second elongated C-shaped channels 50c, 60c facing each other and between which the platform is clamped, FIG. 5. The clamping members 50, 60 typically comprise steel or aluminum sheet or other material that is bent onto itself at one side to form the C-shaped channels 50c, 60c.

The clamping members 50, 60 are adjustably movably disposed on the frame section 40c so to be moved toward one another to clamp onto the platform 20p of the dolly 20 and to be moved away from one another to unclamp from the platform. To this end, the attachment frame section 40c includes first and second pairs of elongated adjustment slots 20s proximate each of the clamping members 50, 60. Threaded fasteners (e.g. bolts) 70 having heads 70h extend through holes provided in flanges 50f, 60f of the clamping members and through the slots 20s to the other side of the frame section 40c where the ends of the threaded fasteners 70 are received by respective threaded nuts 72 in a manner to releasably clamp the clamping members 50, 60 to the platform, FIGS. 5-6.

For example, the snow removal device 10 is releasably attached to the platform 20p of the dolly 20 by positioning the platform between the clamping members 50, 60 and then moving the clamping members toward one another until they clamp onto the edges of the platform 20p as shown in FIGS. 2-4. Then, the nuts 72 are tightened to releasably clamp and lock the snow removal device on the platform 20p. The attachment frame 40 is configured to provide an access space S to allow manual tightening of the nuts 72 using a wrench or other tool to releasably clamp and lock the snow removal device on the platform 20p. The above-described slotted attachment scheme for the clamping members 50, 60 allows attachment to various sized platforms 20p that may employed on different wheeled dollies available commercially and allows the dolly handle angle to be adjusted to the pushing angle desired by the user.

The snow removal device 10 can be removed from the dolly 20 simply by untightening the nuts 72 and moving the clamping members 50, 60 away from one another to release the platform 20p and thus the dolly 20.

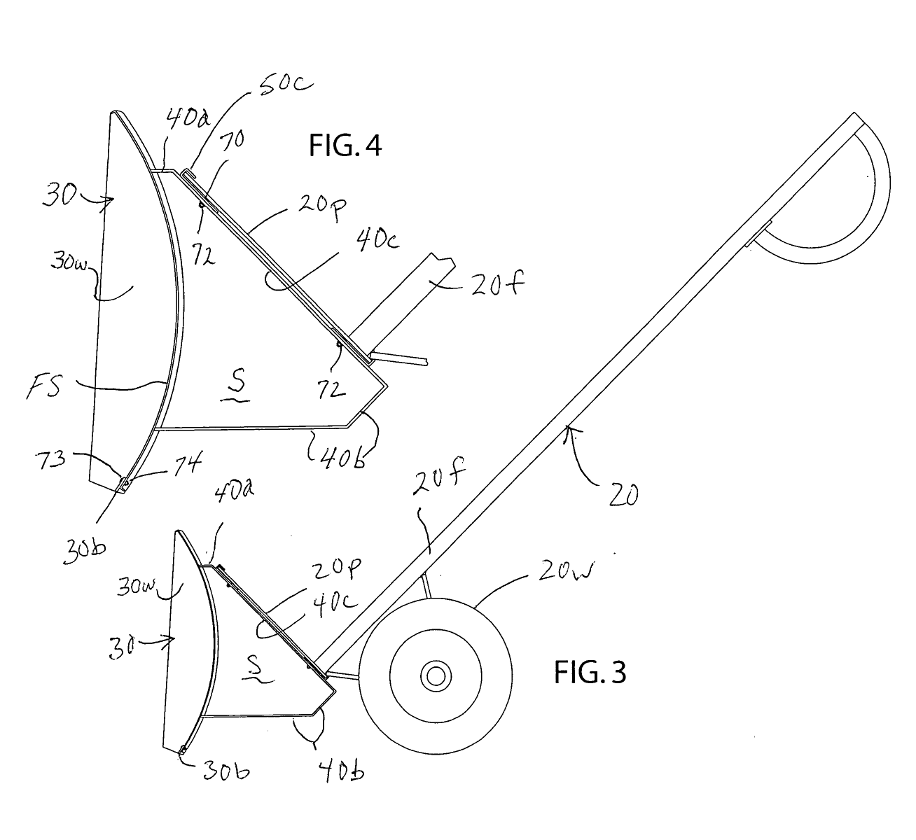

The attachment frame 40 also is configured to orient the snow pushing member 30 as shown in FIGS. 2-3 where a lower edge of the snow pushing member 30 is generally horizontally positioned to push snow from a path, such as a driveway or walkway, when the user pushes the dolly 20 and where the snow pushing member 30 is oriented at an angle to the direction of pushing of the dolly 20 in a manner that some snow is discharged laterally from the snow pushing member 30 (e.g. snow is discharged in the direction of the arrow in FIG. 2) as snow is removed from the path. The snow pushing member 30 includes a closure wall 30w fastened thereto at one end to direct snow toward the opposite open end for discharge.

The snow pushing member 30 preferably includes an optional replaceable blade 30b at the lowermost edge that is adjacent to the surface of the snow-covered path. The replaceable blade 30b can be made of plastic, rubber, metal or any other material and is fastened on the lower edge of the snow pushing member by threaded fasteners 73 and nuts 74 spaced along the length of the blade. The replaceable blade 30b extends the life of the snow removal device and can be employed to adapt to varying surface textures. For example, a plastic or other replaceable blade 30b can be included on the snow pushing member for removing snow from uneven concrete path surfaces. The replaceable blade 30b may be omitted if snow is to be removed only from smooth asphalt surfaces.

The invention is advantageous to provide a snow removal device 10 that is releasably attached to the platform 20p of the dolly 20 for use in removing snow from a path and that can be simply unfastened from the platform 20p of the dolly 20 as described above and stored until the next use in removing snow. In the meantime, the dolly 20 can be used for other tasks.

Although the invention has been described in connection with certain illustrative embodiments thereof, those skilled in the art will appreciate that the invention is not limited to these embodiments and that changes, modifications and the like can be thereto within the scope of the appended claims.

1. Snow removal device, comprising a snow pushing member and an attachment frame that is connected to the snow pushing member and that includes first and second channel-forming clamping members configured to receive respective first and second narrow edges of a platform of a wheeled dolly, wherein the clamping members are adjustably movably disposed on the attachment frame by fasteners extending through adjustment slots on the attachment frame such that the clamping members are movable toward one another in a manner to releasably clamp on the respective first and second narrow edges of the platform of the wheeled dolly.

2. (canceled)

3. The device of claim 1 wherein the first and second clamping members include respective first and second elongated C-shaped channels facing each other.

4. (canceled)

5. The device of claim 1 wherein the frame includes the adjustment slots and wherein the fasteners extend through the clamping members and the slots.

6. The device of claim 1 wherein the frame is attached to the back side of the snow pushing member in a manner to provide an access space between sections of the frame to provide access to the fasteners for releasably clamping the clamping members on the narrow edges of the platform of the dolly.

7. The device of claim 1 wherein the snow pushing member includes a replaceable blade at a lowermost edge.

8. Combination of the snow removal device of claim 1 and a wheeled dolly having a platform wherein the clamping members are releasably clamped on the respective first and second narrow edges of the platform of the dolly.

9. Snow removal device, comprising a snow pushing member and an attachment frame that is connected to the snow pushing member and that includes first and second channel-forming clamping members configured to receive respective front and back narrow edges of a platform of a wheeled dolly wherein the clamping members are adjustably movably disposed on the attachment frame to releasably clamp on the respective front and back narrow edges of the platform.
